(19) United States
(12) Patent Application Publication
(10) Pub. No.: US 2014/0173858 A1
(43) Pub. Date: Jun. 26, 2014

(54) INTEGRATED MULTI-PURPOSE FASTENER

(71) Applicant: Hung-Ming Wu, Sihu Township (TW)

(72) Inventor: Hung-Ming Wu, Sihu Township (TW)

(21) Appl. No.: 13/723,341

(22) Filed: Dec. 21, 2012

(51) Int. Cl. F16B 2/22

(52) U.S. Cl. CPC F16B 2/22
USPC 24/586.11

(57) ABSTRACT

An integrated multi-purpose fastener and allowing summary assembly includes a foldable buckling seat with one end disposed with snap-on device and one end of the snap-on device respectively disposed with movable structures and attachments depending on the function desired.

### BACKGROUND OF THE INVENTION

(a) Field of the Invention

The present invention is related to an innovative construction of a fastener commonly adapted to apparels, personal belongings, IC pocket, mobile phone suspenders, and key chains, and more particularly, to an integrated multi-purpose fastener.

(b) Description of the Prior Art

Fasteners and personal decoration items are frequently seen in the daily life of the modem people. They are essentially comprised of a suspender with one end disposed with a fastener or a decoration item for easy portability or attachment of another object for carrying along and use.

A fastener or a locking piece for personal decoration item is usually made of plastic or metal material or combination of both; and machinery and tool are needed for processing to affect work efficiency while the composition of the fastener or the locking piece provides only a single function. Furthermore, multiple molds are required to increase production cost and frustrate economic utility.

### SUMMARY OF THE INVENTION

The primary purpose of the present invention is to provide an integrated multi-purpose fastener that provides multiples functions and economic and practical benefits. To achieve the purpose, a multi-purpose fastener of the present invention is comprised of multiple buckling seats, buckling plates, and snap-on pillars made in an integrated part that can be folded in and secured in place in conjunction with various accessories to keep ID pocket, mobile phone suspender, key chain, and other personal belongings or decoration items for providing multiple functionalities and economic and practical values.

### BRIEF DESCRIPTION OF THE DRAWINGS

FIG. 1 is an exploded view of a preferred embodiment of the present invention.

FIG. 2 is a perspective view of another preferred embodiment of the present invention.

FIG. 3 is a perspective view showing an extended application of the present invention.

FIG. 4 is another perspective view showing the extended application of the present invention.

FIG. 5 is a perspective view showing another preferred embodiment yet of the present invention.

### DETAILED DESCRIPTION OF THE PREFERRED EMBODIMENTS

To correct the deficiencies found with the fastener and personal decoration items of the prior art, the present invention comprised of a main unit having at its one end disposed with folding in and snapping on accessories to meet various functional requirements provides an integrated multi-purpose fastener in a structure allowing easy process, low cost, and practical effects.

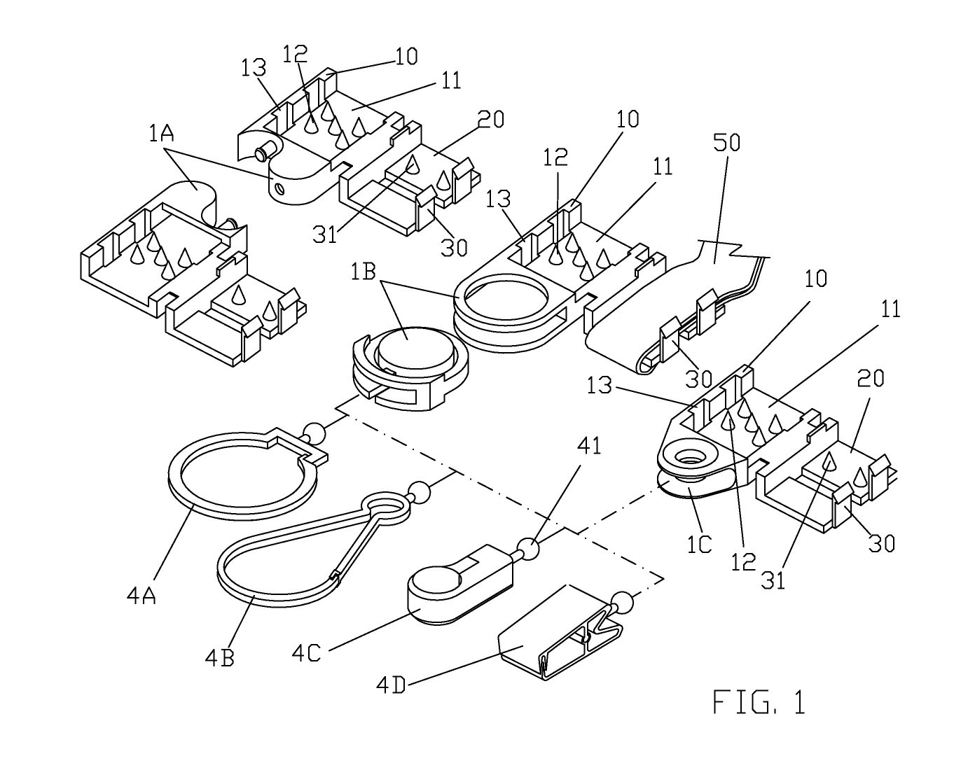

Referring to FIG. 1 for an exploded view showing a preferred embodiment of the present invention, each of multiple buckling seats 10 has a recessed area 11 and multiple snap-on pillars 12 are alternatively are arranged on an inner end of the recessed area 11; multiple buckling holes 13, two as illustrated in the preferred embodiment, are disposed on a wall of the recessed area 11; on the other end opposite to the wall where buckling holes 13 are provided is connected through multiple foldable plates 20, two as illustrated in the preferred embodiment, to multiple buckling plates 30, two additional snap-on pillars 31 are separately disposed on the buckling plates 30 in corresponding to the recessed area 11 on the buckling seat 10 in conjunction with those snap-on pillars 12 and those buckling holes 13; a suspender 50 passes through those foldable plates 20 and then secured by those buckling plates 30 and buckling holes 13; and multiple combination seats 1A, 1B, and 1C are disposed at where in opposition to those buckling seats 10 and buckling plates 30 to be movably inserted with different attachments 4A, 4B, 4C, 4D, etc., as applicable. An end each of those attachments 4A, 4B, 4C, 4D, etc., is provided with an insertion axis to complete an integrated multi-purpose safety fastener.

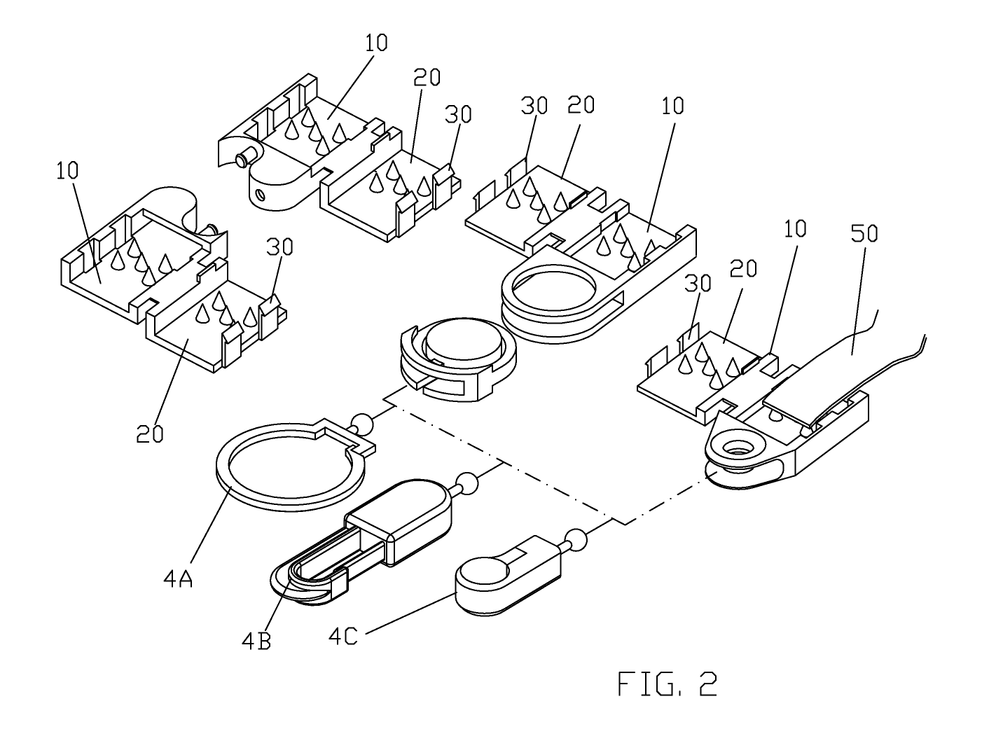

Now referring to another preferred embodiment as illustrated in FIG. 2, the buckling seat 10 and the buckling plate 30 are folded into an integrated party by means of the foldable plate 20. Whereas the foldable plate 20 is flexible to allow folding in, various position or buckling means for the foldable plate 20 is provided as applicable depending on the individual requirements of the suspender 50 and attachments 4A, 4B, 4C, 4D, etc.; therefore, the foldable plate 20 and the buckling plate 30 are made in an integrated part to facilitate direct compression of the suspender 50 in place.

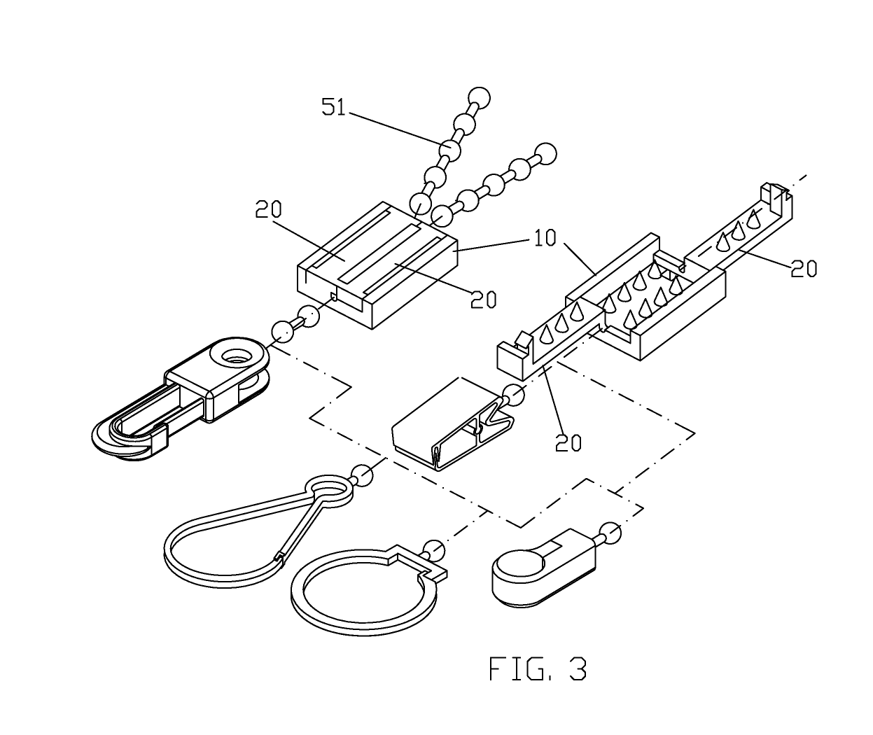

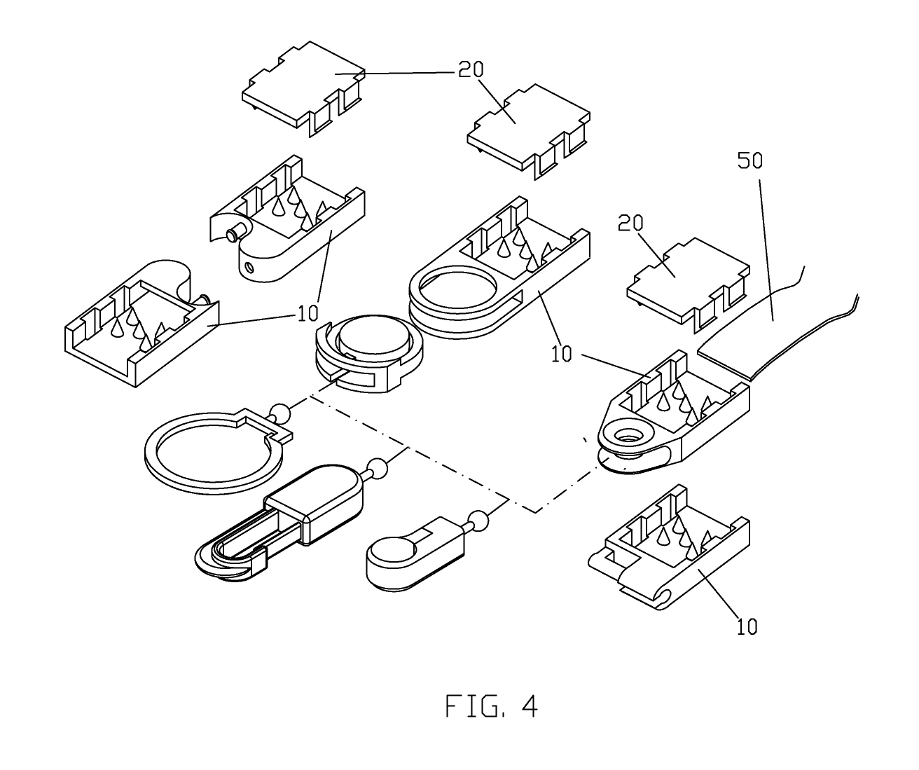

In the extended applications of those preferred embodiments given above as illustrated in FIGS. 3 and 4, both of the foldable plate 20 and the buckling seat 10 are secured to each other by folding in the foldable plate 20 upon the buckling seat 10, other than that as described in those two preferred embodiments described above to allow one or a plurality of the foldable plates, the foldable plate 20 may be folded in different directions (as illustrated in FIG. 3) or is disposed separately from the buckling seat 10 (as illustrated in FIG. 4) to secure the suspender 50 or a bead chain 51.

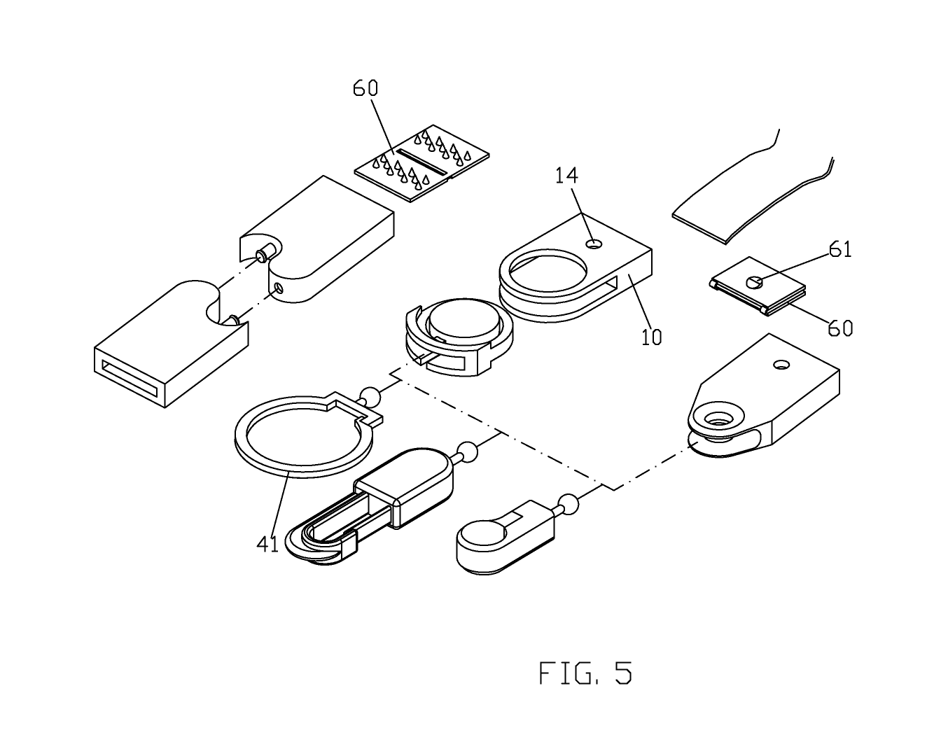

In another preferred embodiment yet of the present invention as illustrated in FIG. 5, the buckling seat 10 is on its inner end made into a square, oval, or circular form and is made in an integrated hollow part; an insertion hole 14 is disposed on one end of the buckling seat; a foldable buckling plate 60 in a shape compromising that of the buckling seat 10 is inserted into a hollow inner end of the buckling seat 10; and a protruding portion 61 is disposed on an external end of the foldable buckling plate 60 in relation to where the insertion hole 14 on the buckling seat 10 is provided. The suspender 50 or a circular band 52 is placed in the foldable buckling plate 60 and then folded and stuffed in the hollow inner end of the buckling seat 10. Accordingly, the suspender 50 or the circular band 52 is secured in place by buckling the protruding portion 61 in the insertion hole 14 for achieving easy assembly of the integrated multiple-purpose fastener.

Those combination seats 1A, 1B, 1C, etc. disposed at the front end of the buckling seat 10 may be provided as required, and then fast connected to attachments 4A, 4B, 4C, 4D, etc. of different functions to put more added value and functionalities to the integrated multi-purpose fastener.

An integrated multi-purpose fastener of the present invention for being foldable to secure in position before connecting to various types of attachment for providing multiple functionalities and practical and economic values meets requirements of patentability; therefore this application is duly filed accordingly.

I claim:

1. An integrated multi-purpose fastener comprising multiple buckling seats; each buckling seat being provided with a recessed area and multiple snap-on pillars alternatively are arranged on an inner end of the recessed area; multiple buckling holes being disposed on a wall of the recessed area; on the other end opposite to the wall where buckling holes are provided being connected through multiple foldable plates to multiple buckling plates, additional snap-on pillars being separately disposed on the buckling plates in corresponding to the recessed area on the buckling seat in conjunction with those snap-on pillars and those buckling holes; a suspender passing through those foldable plates and then secured by those buckling plates and buckling holes; and multiple combination seats being disposed at where in opposition to those buckling seats and buckling plates to be movably inserted with different attachments as applicable; and an end each of those attachments being provided with an insertion axis.

2. The integrated multi-purpose fastener as claimed in claim 1, wherein the buckling seat and the buckling plate are folded into an integrated party by means of the foldable plate; the foldable plate is flexible to allow folding in various position or buckling means for the foldable plate is provided as applicable depending on the individual requirements of the suspender and attachments.

3. The integrated multi-purpose fastener as claimed in claim 1, wherein multiple foldable plates are disposed in different directions and may be made foldable or separately provided.

4. The integrated multi-purpose fastener as claimed in claim 1, wherein the buckling seat is on its inner end made into a square, oval, or circular form and is made in an integrated hollow part; an insertion hole is disposed on one end of the buckling seat; a foldable buckling plate in a shape compromising that of the buckling seat is inserted into a hollow inner end of the buckling seat; and a protruding portion is disposed on an external end of the foldable buckling plate in relation to where the insertion hole on the buckling seat is provided.

5. The integrated multi-purpose fastener as claimed in claim 1, wherein a combination seat is disposed to a front end of the buckling seat as applicable; and one end of the combination seat is fast connected to an attachment depending on the function as desired.

6. The integrated multi-purpose fastener as claimed in claim 1, wherein the buckling seat, multiple buckling plates, and multiple snap-on pillars are linked by foldable plates to become an integrated part; the fastener is foldable to secure a suspender, a bead chain, or a circular band to adapt to garment apparels, personal belongings, ID pocket, mobile phone strap, and key chain in conjunction with various types of attachments to provide multiple functions and economic and practical values.
